(19) United States
(12) Patent Application Publication
(10) Pub. No.: US 2017/0054508 A1
(43) Pub. Date: Feb. 23, 2017

(54) OPTICAL TRANSMISSION DEVICE AND METHOD FOR DETERMINING CONNECTION

(71) Applicant: FUJITSU LIMITED, Kawasaki-shi (JP)

(72) Inventors: Hideki Kobayashi, Yokohama (JP); Jyunichi Ishiwatari, Kawasaki (JP)

(73) Assignee: FUJITSU LIMITED, Kawasaki-shi (JP)

(21) Appl. No.: 15/233,435

(22) Filed: Aug. 10, 2016

(30) Foreign Application Priority Data
Aug. 21, 2015 (JP) 2015-164012

(51) Int. Cl. H04B 10/50; H04B 10/275; H04J 14/02

(52) U.S. Cl. CPC H04B 10/50; H04J 14/021; H04B 10/275

(57) ABSTRACT

There is provided an optical transmission device including: a first coupler to which an optical signal including an amplified spontaneous emission is input; a first filter configured to transmit the optical signal having a first frequency band from the first coupler; a first optical detector configured to detect an optical intensity of the optical signal transmitted through the first filter; a first port coupled to the first coupler; a second port configured to be coupled to the first port; a second coupler coupled to the second port; a second filter configured to transmit the optical signal having a second frequency band matching the first frequency band from the second coupler; and a reflector configured to reflect the optical signal from the second filter.

### CROSS-REFERENCE TO RELATED APPLICATION

This application is based upon and claims the benefit of priority of the prior Japanese Patent Application No. 2015-164012, filed on Aug. 21, 2015, the entire contents of which are incorporated herein by reference.

### FIELD

The embodiments discussed herein are related to an optical transmission device and a method for determining connection.

### BACKGROUND

An optical communication system including a plurality of optical transmission devices that form a communication network is known (see, e.g., Japanese Laid-Open Patent Publication No. 2006-191212). Each optical transmission device is connected with other optical transmission devices via a plurality of communication cables, respectively. Each optical transmission device includes a switch unit that connects any of a plurality of optical signals received from other optical transmission devices, to a transponder.

### SUMMARY

According to an aspect of the invention, an optical transmission device includes: a first coupler to which an optical signal including an amplified spontaneous emission is input; a first filter configured to transmit the optical signal having a first frequency band from the first coupler; a first optical detector configured to detect an optical intensity of the optical signal transmitted through the first filter; a first port coupled to the first coupler; a second port configured to be coupled to the first port; a second coupler coupled to the second port; a second filter configured to transmit the optical signal having a second frequency band matching the first frequency band from the second coupler; and a reflector configured to reflect the optical signal from the second filter.

The object and advantages of the disclosure will be realized and attained by means of the elements and combinations particularly pointed out in the claims.

It is to be understood that both the foregoing general description and the following detailed description are exemplary and explanatory and are not restirctive of the disclosure, as claimed.

### BRIEF DESCRIPTION OF DRAWINGS

FIG. 1 is a block diagram illustrating an example of the configuration of an optical communication system according to a first embodiment;

FIG. 2 is a block diagram illustrating an example of the configuration of an optical transmission device of FIG. 1;

FIG. 3 is a block diagram illustrating an example of the configuration of a receiver of FIG. 2;

FIG. 4 is a graph illustrating an example of a frequency band of optical signal which transmits through an amplification unit filter of FIG. 3;

FIG. 5 is a table illustrating an example of an intensity-connection relationship stored in a storage unit of FIG. 2;

FIG. 6 is a block diagram illustrating an example of the configuration of a receiver according to a second embodiment;

FIG. 7 is a block diagram illustrating an example of the configuration of a receiver according to a third embodiment;

FIG. 8 is a table illustrating an example of an intensity-connection relationship stored in a storage unit of the third embodiment;

FIG. 9 is a block diagram illustrating an example of the configuration of a receiver according to a fourth embodiment; and

FIG. 10 is a block diagram illustrating an example of the configuration of a transmitter according to a fifth embodiment.

### DESCRIPTION OF EMBODIMENTS

An optical transmission device includes, for example, an amplification unit including a plurality of amplifiers which amplifies a plurality of received optical signals, respectively, and a switch unit connecting any of a plurality of optical signals, which is output from the amplification unit, to a transponder. The amplification unit and the switch unit are interconnected via a plurality of communication cables through which the plurality of optical signals are transmitted, respectively. Therefore, each of the amplification unit and the switch unit has a plurality of ports to which the plurality of communication cables are respectively connected.

When a port serving as a connection destination of a communication cable is incorrectly selected, there may be a case where a port of the amplification unit and a port of the switch unit are incorrectly connected. In addition, when a communication network formed by an optical communication system has a mesh-type network topology, the number of other optical transmission devices connected to each optical transmission device tends to be increased. Accordingly, in this case, there is an increased possibility of incorrect connection between the port of the amplification unit and the port of the switch unit. However, it is difficult for the optical transmission devices to determine whether the port connection is correctly performed.

Hereinafter, embodiments of techniques for detecting the correctness or incorrectness of connection between ports will be described with reference to drawings. However, the embodiments described below are just illustrative. Therefore, embodiments disclosed herein are not intended to exclude a variety of modifications and techniques which are not specifically stated in the following description. Throughout the drawings used in the following embodiments, the same or similar portions are denoted by the same reference numerals unless modifications or variations are explicitly stated.

### First Embodiment

### [Configuration]

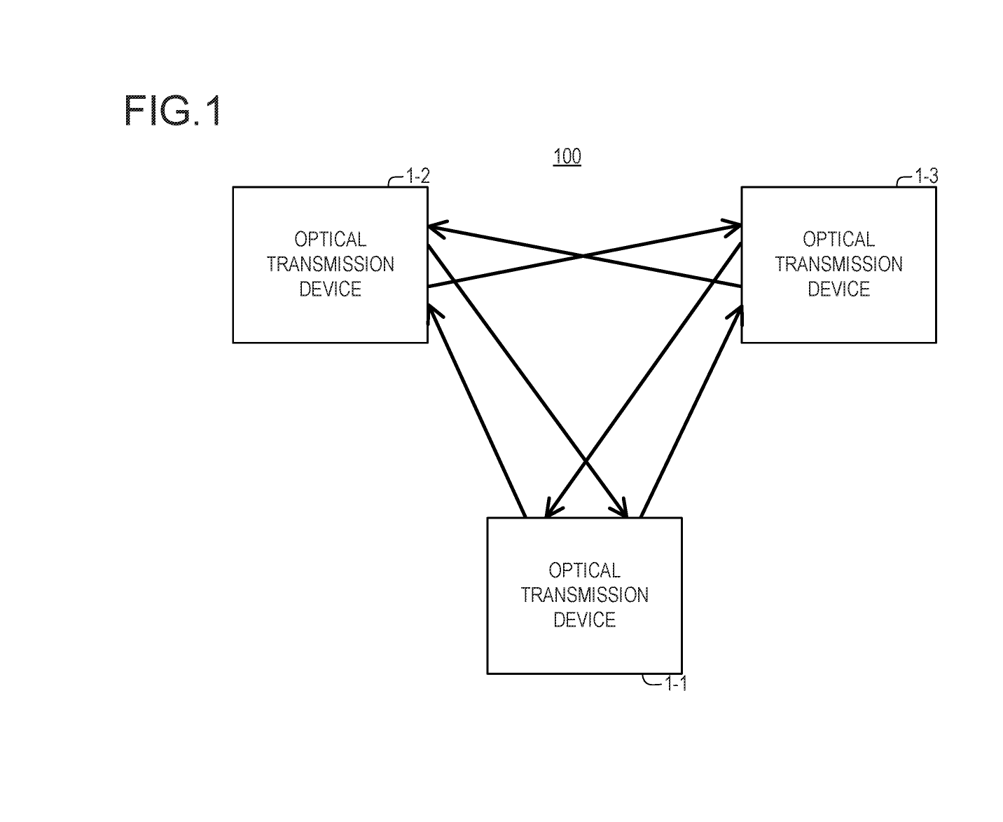

For example, as illustrated in FIG. 1, an optical communication system 100 according to a first embodiment includes N optical transmission devices 1-1, . . . , 1-N, where, N represents an integer of 2 or more (3 in this embodiment). In the following description, an optical transmission device 1-n is also referred to as an optical transmission device 1 as long as it is not necessary to distinguish one from another, where, n represents an integer of 1 to N.

The optical communication system 100 performs communication by exchanging optical signals among optical transmission devices 1. In this embodiment, each optical transmission device 1 transmits and receives an optical signal according to wavelength division multiplexing (WDM). In this embodiment, each optical transmission device 1 acts as a reconfigurable optical add/drop multiplexer (ROADM) node.

In this embodiment, a communication network formed by N optical transmission devices 1-1, . . . , 1-N has a ring-type network topology. In the meantime, the communication network formed by the N optical transmission devices 1-1, . . . , 1-N may have a mesh-type network topology.

In this embodiment, the optical communication system 100 includes a first transmission line of a clockwise direction and a second transmission line of a counterclockwise direction. The first transmission line is formed with a transmission line for transmitting an optical signal from the optical transmission device 1-1 to the optical transmission device 1-2, a transmission line for transmitting an optical signal from the optical transmission device 1-2 to the optical transmission device 1-3, and a transmission line for transmitting an optical signal from the optical transmission device 1-3 to the optical transmission device 1-1. The second transmission line is formed with a transmission line for transmitting an optical signal from the optical transmission device 1-1 to the optical transmission device 1-3, a transmission line for transmitting an optical signal from the optical transmission device 1-3 to the optical transmission device 1-2, and a transmission line for transmitting an optical signal from the optical transmission device 1-2 to the optical transmission device 1-1.

In this embodiment, an optical transmission device 1-n is connected to other optical transmission devices 1-i and 1-j via a communication cable. In this embodiment, the connection represents an optical connection, where, i and j represent different integers of natural numbers which are equal to or smaller than N and are different from n. In this embodiment, the communication cable includes an optical fiber.

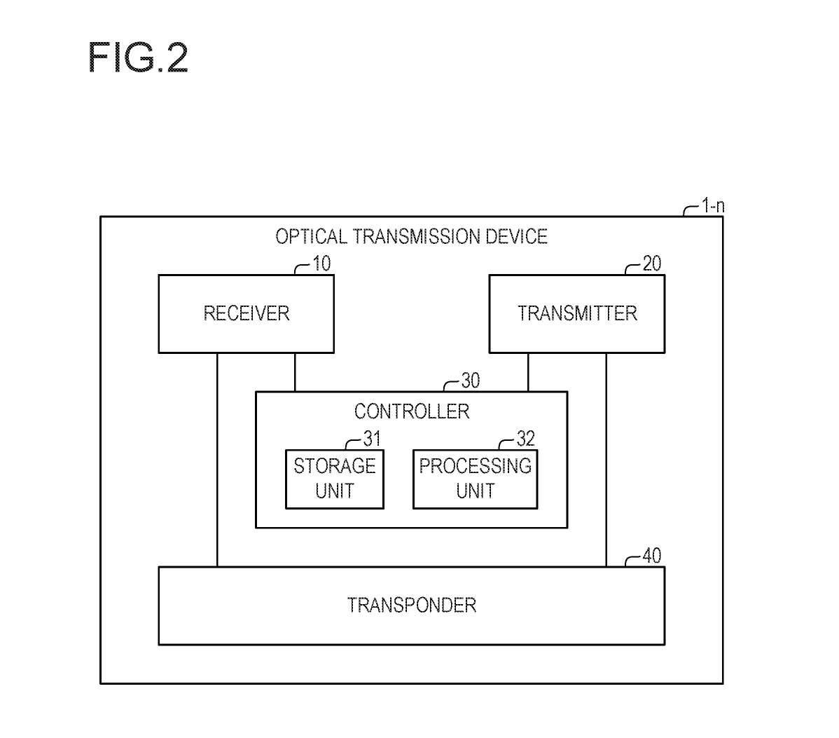

For example, as illustrated in FIG. 2, the optical transmission device 1-n includes a receiver 10, a transmitter 20, a controller 30, and a transponder 40.

The receiver 10 receives a plurality of optical signals from the other optical transmission devices 1-i and 1-j connected to the optical transmission device 1-n. The receiver 10 outputs one selected from the plurality of received optical signals to the transponder 40.

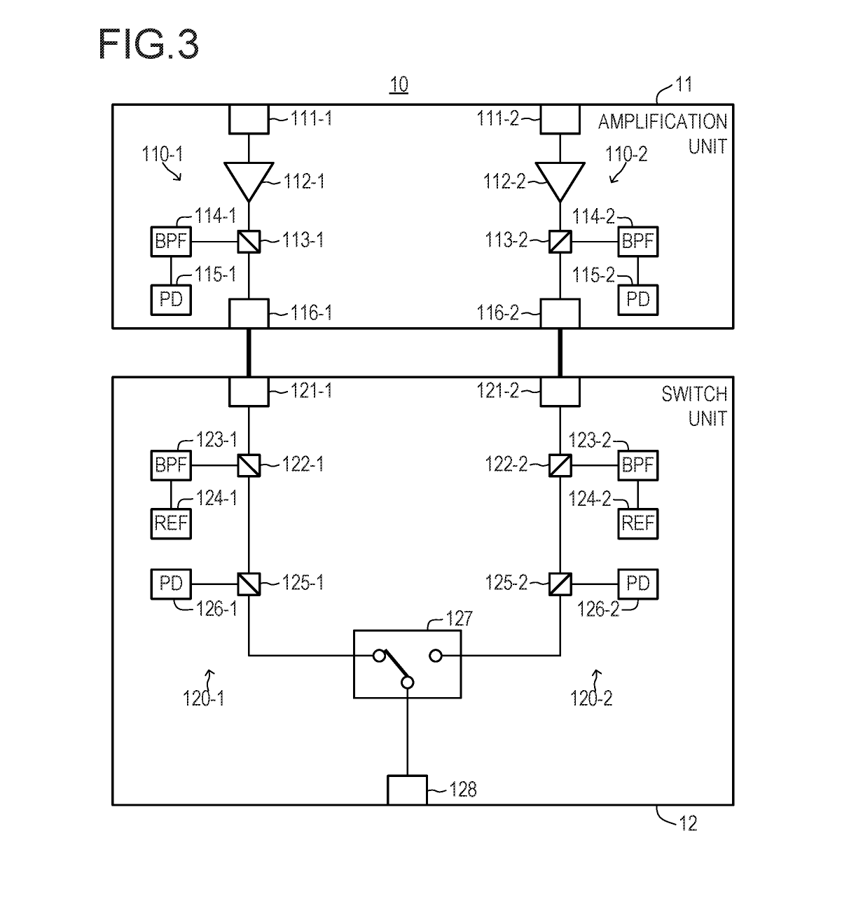

For example, as illustrated in FIG. 3, the receiver 10 includes an amplification unit 11 and a switch unit 12. The amplification unit 11 and the switch unit 12 may be configured as two different devices from each other.

The amplification unit 11 includes M sets of element groups 110-1, . . . , 110-M, where, M represents an integer of 2 or more (2 in this embodiment). In the following description, an element group 110-m is also referred to as an element group 110 as long as it is not necessary to distinguish one from another, where, m represents an integer of 1 to M. The M sets of element groups 110-1, . . . , 110-M may constitute M different devices, respectively.

The element group 110-m includes an amplification unit input side port 111-m, an amplifier 112-m, an amplification unit coupler 113-m, an amplification unit filter 114-m, an amplification unit optical detector 115-m, and an amplification unit output side port 116-m. The filter may be represented as a band-pass-filter (BPF). The optical detector may be represented as a photodetector (PD).

The amplification unit coupler 113-m is one example of a first coupler. The amplification unit filter 114-m is one example of a first filter. The amplification unit optical detector 115-m is one example of a first optical detector. The amplification unit output side port 116-m is one example of a first port.

The amplification unit input side port 111-m is, for example, configured to allow its one end to be connected to the other end of a communication cable connected to the other optical transmission device 1-i or 1-j. In addition, the amplification unit input side port 111-m is connected to an input terminal of the amplifier 112-m, as will be described later.

The amplifier 112-m has the input terminal which receives optical signal and is connected to the amplification unit input side port 111-m. The amplifier 112-m amplifies the optical signal input from the input terminal. In this embodiment, the amplifier 112-m is an erbium doped fiber amplifier (EDFA). The amplifier 112-m has an output terminal which outputs the amplified optical signal and is connected to the amplification unit coupler 113-m. The optical signal output by the amplifier 112-m includes amplified spontaneous emission (ASE).

The amplification unit coupler 113-m is connected to each of the output terminal of the amplifier 112-m, the amplification unit filter 114-m, and the amplification unit output side port 116-m. The amplification unit coupler 113-m outputs the optical signal, which is input from the output terminal of the amplifier 112-m, to the amplification unit output side port 116-m. Further, the amplification unit coupler 113-m splits the optical signal input from the amplification unit output side port 116-m into two optical signals and outputs one of the two optical signals to the amplification unit filter 114-m. In this embodiment, the amplification unit coupler 113-m is a single directional coupler.

The amplification unit filter 114-m is connected to each of the amplification unit coupler 113-m and the amplification unit optical detector 115-m. The amplification unit filter 114-m transmits a component of the input optical signal which has an m^{th} frequency band. In this embodiment, the amplification unit filter 114-m outputs the component having the m^{th} frequency band, of the optical signal input from the amplification unit coupler 113-m, to the amplification unit optical detector 115-m while blocking components having frequencies different from the m^{th} frequency band, of the input optical signal.

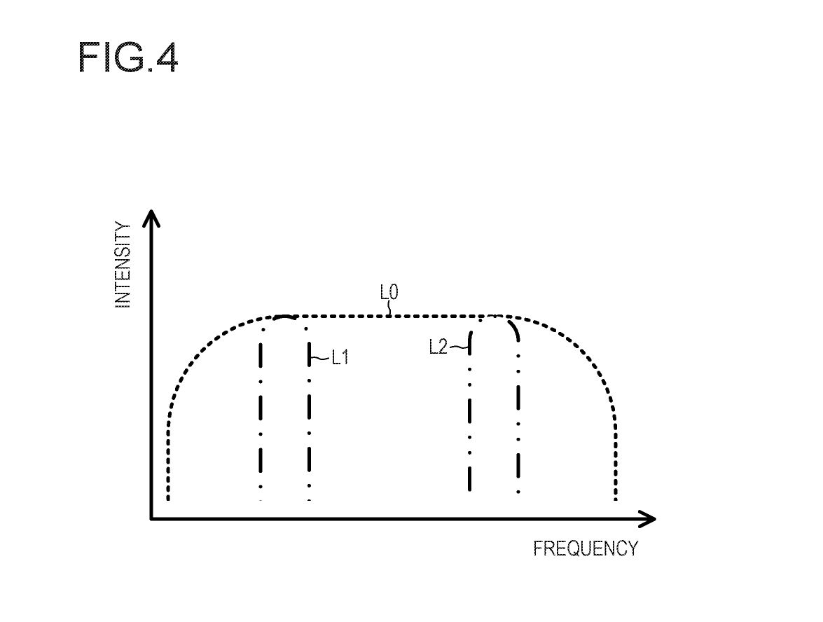

First to M^{th} frequency bands are different from each other. In this embodiment, as illustrated in FIG. 4, the first frequency band of optical signal L1 transmitting through the amplification unit filter 114-1 is lower than the second frequency band of optical signal L2 transmitting through the amplification unit filter 114-2.

The amplification unit optical detector 115-m is connected to the amplification unit filter 114-m. The amplification unit optical detector 115-m detects the optical intensity input from the amplification unit filter 114-m (in other words, optical signal transmitted through the amplification unit filter 114-m). In this embodiment, the amplification unit optical detector 115-m includes a photodiode.

The amplification unit output side port 116-m is connected to the amplification unit coupler 113-m. Further, the amplification unit output side port 116-m is, for example, configured to allow its one end to be connected to the other end of a communication cable connected to a switch unit input side port 121-m which will be described later. The amplification unit output side port 116-m outputs optical signal, which is input from the communication cable, to the amplification unit coupler 113-m and outputs optical signal, which is input from the amplification unit coupler 113-m, to the communication cable.

The switch unit 12 includes M sets of element groups 120-1, . . . , 120-M, a switch 127, and a switch unit output side port 128. In the following description, an element group 120-m is also referred to as an element group 120 as long as it is not necessary to distinguish one from another. The switch unit output side port 128 is one example of a third port.

The element group 120-m includes a switch unit input side port 121-m, a switch unit input side coupler 122-m, a switch unit filter 123-m, a reflector (REF) 124-m, a switch unit output side coupler 125-m, and a switch unit optical detector 126-m.

The switch unit input side port 121-m is one example of a second port. The switch unit input side coupler 122-m is one example of a second coupler. The switch unit filter 123-m is one example of a second filter. M reflectors 124-1, . . . , 124-M are one example of a reflector. The switch unit optical detector 126-m is one example of a second optical detector.

The switch unit input side port 121-m is, for example, configured to allow its one end to be connected to the other end of a communication cable connected to the amplification unit output side port 116-m. In addition, the switch unit input side port 121-m is connected to the switch unit input side coupler 122-m. The switch unit input side port 121-m outputs optical signal, which is input from the communication cable, to the switch unit input side coupler 122-m and outputs optical signal, which is input from the switch unit input side coupler 122-m, to the communication cable.

The switch unit input side coupler 122-m is connected to each of the switch unit input side port 121-m, the switch unit filter 123-m, and the switch unit output side coupler 125-m. The switch unit input side coupler 122-m splits the optical signal input from the switch unit input side port 121-m into two optical signals and outputs one of the two optical signals to the switch unit filter 123-m while outputting the other of the two optical signals to the switch unit output side coupler 125-m.

Further, the switch unit input side coupler 122-m outputs optical signal, which is input from the switch unit output side coupler 125-m, to the switch unit input side port 121-m. In addition, the switch unit input side coupler 122-m outputs optical signal, which is input from the switch unit filter 123-m, to the switch unit input side port 121-m. In this embodiment, the switch unit input side coupler 122-m is a single directional coupler.

The switch unit filter 123-m is connected to each of the switch unit input side coupler 122-m and the reflector 124-m. The switch unit filter 123-m transmits a component having an M^{th} frequency band, of the input optical signal.

In this embodiment, the switch unit filter 123-m outputs a component having an M^{th} frequency band, of the optical signal input from the switch unit input side coupler 122-m, to the reflector 124-m while blocking components having frequencies different from the M^{th} frequency band, of the input optical signal. In addition, in this embodiment, the switch unit filter 123-m outputs a component having an M^{th} frequency band, of the optical signal input from the reflector 124-m, to the switch unit input side coupler 122-m while blocking components having frequencies different from the M^{th} frequency band, of the input optical signal.

In this way, a frequency band of the optical signal transmitting through the switch unit filter 123-m (in other words, the M^{th} frequency band) matches a frequency band of the optical signal transmitting through the amplification unit filter 114-m corresponding to the switch unit filter 123-m (in other words, the M^{th} frequency band).

The reflector 124-m is connected to the switch unit filter 123-m. The reflector 124-m reflects optical signal input from the switch unit filter 123-m and outputs the reflected optical signal to the switch unit filter 123-m.

The switch unit output side coupler 125-m is connected to each of the switch unit input side coupler 122-m, the switch unit optical detector 126-m, and the switch 127. The switch unit output side coupler 125-m splits the optical signal input from the switch unit input side coupler 122-m into two optical signals and outputs one of the two optical signals to the switch unit optical detector 126-m while outputting the other of the two optical signals to the switch 127. In addition, the switch unit output side coupler 125-m splits the optical signal input from the switch 127 into two optical signals and outputs one of the two optical signals to the switch unit optical detector 126-m while outputting the other of the two optical signals to the switch unit input side coupler 122-m. In this embodiment, the switch unit output side coupler 125-m is a dual directional coupler.

The switch unit optical detector 126-m is connected to the switch unit output side coupler 125-m. The switch unit optical detector 126-m detects the optical intensity input from the switch unit output side coupler 125-m. In this embodiment, the switch unit output side coupler 125-m includes a photodiode.

The switch 127 is connected to the switch unit output side port 128 and each of M switch unit output side couplers 125-1, . . . , 125-M. The switch 127 connects the switch unit output side port 128 and one of the M switch unit output side couplers 125-1, . . . , 125-M. Further, the switch 127 switches the switch unit output side coupler 125-m, which is connected to the switch unit output side port 128, among the M switch unit output side couplers 125-1, . . . , 125-M.

When connecting the switch unit output side port 128 and the switch unit output side coupler 125-m, the switch 127 outputs optical signal, which is input from the switch unit output side port 128, to the switch unit output side coupler 125-m. Further, in this case, the switch 127 outputs optical signal, which is input from the switch unit output side coupler 125-m, to the switch unit output side port 128.

The switch unit output side port 128 is connected to the switch 127. Further, the switch unit output side port 128 is, for example, configured to allow its one end to be connected to the other end of a communication cable connected to the transponder 40. The switch unit output side port 128 outputs optical signal, which is input from the communication cable, to the switch 127 while outputting optical signal, which is input from the switch 127, to the communication cable.

An optical signal is input from the transponder 40 to the transmitter 20. The transmitter 20 transmits the optical signal, which is input from the transponder 40, to an optical transmission device 1 selected from other optical transmission devices 1-i and 1-j connected to the optical transmission device 1-n.

The controller 30 includes a storage unit 31 and a processing unit 32. The storage unit 31 stores a relationship between the optical intensity and the correctness/incorrectness of connection between the M amplification unit output side ports 116-1, . . . , 116-M and the M switch unit input side ports 121-1, . . . , 121-M (in other words, an intensity-connection relationship). The storage unit 31 is one example of a memory, and the processing unit 32 may be, for example, configured with a digital signal processor (DSP) that is a kind of a hardware processor or a central processing unit (CPU) driven by software.

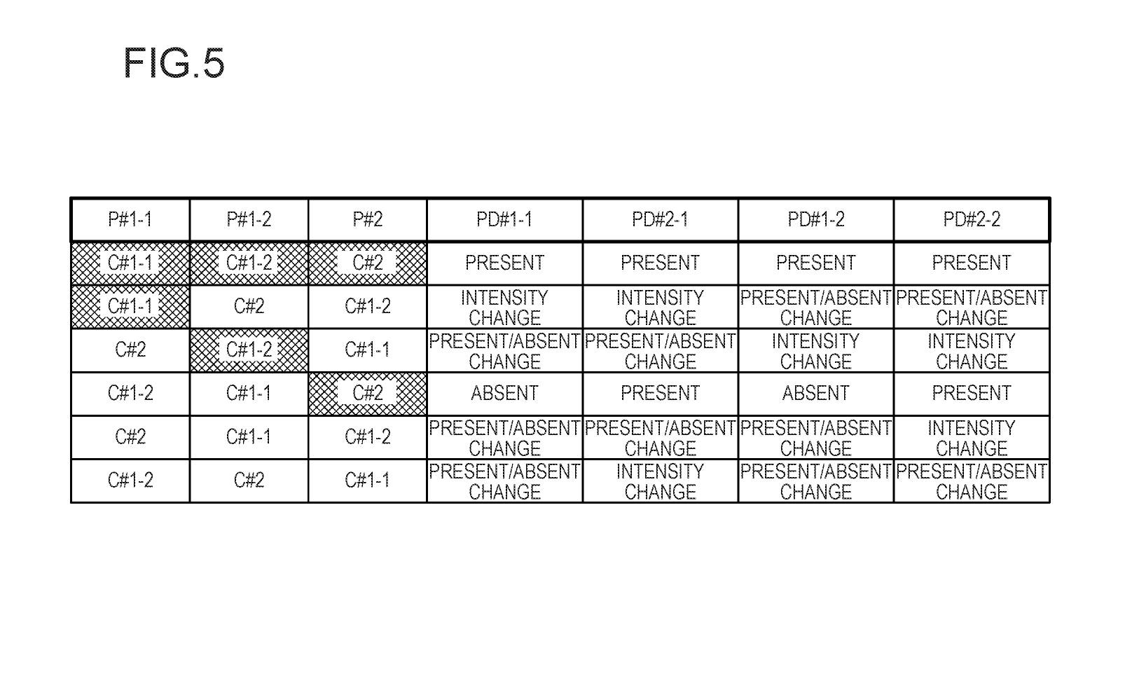

In this embodiment, as illustrated in FIG. 5, the intensity connection relationship includes a relationship between the optical intensity for each of four optical detectors 115-1, 126-1, 115-2, and 126-2 and the correctness/incorrectness of connection for each of three ports 121-1, 121-2 and 128. In the meantime, it may be understood that the correctness/incorrectness of connection for each of the two switch unit input side ports 121-1, and 121-2 is the correctness/incorrectness of connection for each of the two amplification unit output side ports 116-1 and 116-2.

In FIG. 5, “P#1-1,” “P#1-2” and “P#2” denote the switch unit input side port 121-1, the switch unit input side port 121-2, and the switch unit output side port 128, respectively. Further, “PD#1-1,” “PD#2-1,” “PD#1-2” and “PD#2-2” denote the amplification unit optical detector 115-1, the switch unit optical detector 126-1, the amplification unit optical detector 115-2, and the switch unit optical detector 126-2, respectively.

In addition, “C#1-1,” “C#1-2” and “C#2” denote the amplification unit output side port 116-1, the amplification unit output side port 116-2, and a port of the transponder 40, respectively.

Further, “Present” and “Absent” represent that the optical intensity is larger than a predetermined threshold and that the optical intensity is equal to or smaller than the threshold, respectively. In this embodiment, moreover, the “Present” and “Absent” represent that the optical intensity is not changed when the switch unit output side coupler 125-m connected to the switch unit output side port 128 is switched.

In addition, “Presence/Absence Change” represents that the optical intensity is changed between a state where it is larger than the threshold and a state where it is equal to or smaller than the threshold when the switch 127 switches the switch unit output side coupler 125-m connected to the switch unit output side port 128.

Further, “Intensity Change” represents that the optical intensity is larger than the threshold and is changed when the switch 127 switches the switch unit output side coupler 125-m connected to the switch unit output side port 128.

For example, descriptions will be made on a case where all of optical signal intensities for “PD#1-1,” “PD#2-1,” “PD#1-2” and “PD#2-2” in the intensity-connection relationship are “Present.” In other words, this case is a case where the optical intensity for each of the four optical detectors 115-1, 126-1, 115-2 and 126-2 is larger than the threshold.

In this case, the intensity-connection relationship represents that “C#1-1,” “C#1-2” and “C#2” are connected to “P#1-1,” “P#1-2” and “P#2,” respectively. In other words, in this case, the intensity-connection relationship represents that the amplification unit output side port 116-1, the amplification unit output side port 116-2, and the port of the transponder 40 are connected to the three ports 121-1, 121-2, and 128, respectively. Accordingly, in this case, all of connections for the three ports 121-1, 121-2, and 128 are correct.

Next, for example, descriptions will be made on a case where the optical signal intensities for “PD#1-1,” “PD#2-1,” “PD#1-2” and “PD#2-2” in the intensity-connection relationship are “Intensity Change,” “Intensity Change,” “Absent” and “Presence/Absence Change,” respectively. In other words, this case is a case where the optical intensity for each of the optical detectors 115-1 and 126-1 is larger than the threshold and is changed before and after the switching. Further, this case is a case where the optical intensity for the optical detector 115-2 is equal to smaller than the threshold and the optical intensity for the optical detector 126-2 is changed between a state where it is larger than the threshold and a state where it is equal to or smaller than the threshold before and after the switching.

In this case, the intensity-connection relationship represents that “C#1-1,” “C#2” and “C#1-2” are connected to “P#1-1,” “P#1-2” and “P#2,” respectively. In other words, in this case, the intensity-connection relationship represents that the amplification unit output side port 116-1, the port of the transponder 40, and the amplification unit output side port 116-2 are connected to the three ports 121-1, 121-2 and 128, respectively. Accordingly, in this case, connection for one port 121-1 is correct and connections for the two ports 121-2 and 128 are incorrect.

Next, for example, descriptions will be made on a case where the optical signal intensities for “PD#1-1,” “PD#2-1,” “PD#1-2” and “PD#2-2” in the intensity-connection relationship are “Presence/Absence Change,” “Intensity Change,” “Presence/Absence Change” and “Presence/Absence Change,” respectively. In other words, this case is a case where the optical intensity for each of the optical detectors 115-1, 115-2, and 126-2 is changed between a state where it is larger than the threshold and a state where it is equal to or smaller than the threshold before and after the switching. Further, this case is a case where the optical intensity for the optical detector 126-1 is larger than the threshold and is changed before and after the switching.

In this case, the intensity-connection relationship represents that “C#1-2,” “C#2” and “C#1-1” are connected to “P#1-1,” “P#1-2” and “P#2,” respectively. In other words, in this case, the intensity-connection relationship represents that the amplification unit output side port 116-2, the port of the transponder 40, and the amplification unit output side port 116-1 are connected to the three ports 121-1, 121-2 and 128, respectively. Accordingly, in this case, connections for the three ports 121-1, 121-2 and 128 are incorrect. The above description may be applied to other cases in the same manner.

The processing unit 32 determines the correctness/incorrectness of connection for each of the three ports 121-1, 121-2, and 128 based on the optical intensity detected by each of the four optical detectors 115-1, 115-2, 126-1, and 126-2 and the intensity-connection relationship stored in the storage unit 31.

In this embodiment, the processing unit 32 controls the switch 127 to switch the switch unit output side coupler 125-m connected to the switch unit output side port 128. The processing unit 32 acquires the optical intensity detected by each of the four optical detectors 115-1, 115-2, 126-1, and 126-2 at the point of time before the switching and at the point of time after the switching.

The processing unit 32 determines whether or not the acquired optical intensity is larger than the threshold. Further, based on a result of the determination and the intensity-connection relationship stored in the storage unit 31, the processing unit 32 determines the correctness/incorrectness of connection for each of the three ports 121-1, 121-2, and 128.

Moreover, a threshold for the amplification unit optical detector 115-m may be different from a threshold for the switch unit optical detector 126-m.

The transponder 40 transforms an optical signal input from the receiver 10 into an electrical signal. Further, the transponder 40 transforms an electrical signal into an optical signal which is then output to the transmitter 20.

### [Operation]

Next, one example of the operation of an optical transmission device 1-n will be described. In this embodiment, in a period during which no transmission/reception of an optical signal between optical transmission devices 1 is performed (in other words, in a period during which no optical signal is output from the transponder 40), the optical communication system 100 determines the correctness/incorrectness of connection between ports in the optical transmission devices 1. For example, the period during which no transmission/reception of an optical signal between optical transmission devices 1 is performed may be a period before transmission/reception of an optical signal between optical transmission devices 1 begins to be performed.

### [When Connection of Each Port is Correct]

A case where the amplification unit output side port 116-1, the amplification unit output side port 116-2, and the port of the transponder 40 are connected to the switch unit input side port 121-1, the switch unit input side port 121-2, and the switch unit output side port 128, respectively, will be described below. In other words, a case where connections for the switch unit input side port 121-1, the switch unit input side port 121-2, and the switch unit output side port 128 are correct will be described.

The optical transmission device 1-n controls the switch 127 to connect the switch unit output side coupler 125-1 and the switch unit output side port 128.

In this case, an optical signal including the amplified spontaneous emission (ASE) output from the amplifier 112-1 reaches the switch unit filter 123-1 after passing through the amplification unit coupler 113-1, the amplification unit output side port 116-1, the switch unit input side port 121-1 and the switch unit input side coupler 122-1 in turn. A component having a first frequency band, of the optical signal reaching the switch unit filter 123-1, is reflected by the reflector 124-1 after passing through the switch unit filter 123-1.

Further, the reflected optical signal reaches the amplification unit filter 114-1 after passing through the switch unit filter 123-1, the switch unit input side coupler 122-1, the switch unit input side port 121-1, the amplification unit output side port 116-1, and the amplification unit coupler 113-1 in turn. A frequency band of the reflected optical signal matches the first frequency band. Therefore, the optical signal reaching the amplification unit filter 114-1 reaches the amplification unit optical detector 115-1 after passing through the amplification unit filter 114-1. Accordingly, in this case, the optical intensity detected by the amplification unit optical detector 115-1 is larger than the threshold.

In addition, the amplified spontaneous emission reaches the switch unit optical detector 126-1 after passing through the amplification unit coupler 113-1, the amplification unit output side port 116-1, the switch unit input side port 121-1, the switch unit input side coupler 122-1, and the switch unit output side coupler 125-1 in turn. Accordingly, in this case, the optical intensity detected by the switch unit optical detector 126-1 is larger than the threshold.

Similarly, an optical signal including the amplified spontaneous emission output from the amplifier 112-2 is reflected by the reflector 124-2 and the reflected optical signal reaches the amplification unit optical detector 115-1. In addition, the amplified spontaneous emission reaches the switch unit optical detector 126-2. Accordingly, the optical intensity detected by each of the optical detectors 115-2 and 126-2 is larger than the threshold.

The optical transmission device 1-n acquires the optical intensity detected by the four optical detectors 115-1, 115-2, 126-1 and 126-2. In this case, as described above, the optical transmission device 1-n acquires the optical intensity larger than the threshold from the four optical detectors 115-1, 115-2, 126-1 and 126-2.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, like before the switching, optical signal is guided. Then, the optical transmission device 1-n acquires the optical intensity detected by the four optical detectors 115-1, 115-2, 126-1 and 126-2. In this case, like before the switching, the optical transmission device 1-n acquires the optical intensity larger than the threshold from the four optical detectors 115-1, 115-2, 126-1 and 126-2.

Then, based on the optical intensity detected at the point of time before the switching and at the point of time after the switching and the intensity-connection relationship stored in the storage unit 31, the optical transmission device 1-n determines the correctness/incorrectness of connection between ports. In this case, the optical transmission device 1-n determines that connections for the three ports 121-1, 121-2 and 128 are correct.

### [When Only Connection of One Port is Correct]

A case where the amplification unit output side port 116-1, the port of the transponder 40 and the amplification unit output side port 116-2 are connected to the switch unit input side port 121-1, the switch unit input side port 121-2, and the switch unit output side port 128, respectively, will be described below. In other words, a case where connection for the switch unit input side port 121-1 is correct and connections for the switch unit input side port 121-2 and the switch unit output side port 128 are incorrect will be described.

The optical transmission device 1-n controls the switch 127 to connect the switch unit output side coupler 125-1 and the switch unit output side port 128.

In this case, like the above-described case, an optical signal including the amplified spontaneous emission output from the amplifier 112-1 reaches the optical detectors 115-1 and 126-1. Further, the optical signal reaching the switch unit output side coupler 125-1, of the amplified spontaneous emission, reaches the amplification unit filter 114-2 after passing through the switch 127, the switch unit output side port 128, the amplification unit output side port 116-2, and the amplification unit coupler 113-2 in turn.

A component having a second frequency band, of the optical signal reaching the amplification unit filter 114-2, reaches the amplification unit optical detector 115-2 after passing through the amplification unit filter 114-2. In the meantime, the optical signal including the amplified spontaneous emission output from the amplifier 112-1 does not reach the switch unit optical detector 126-2.

Further, in this case, the optical signal including the amplified spontaneous emission output from the amplifier 112-2 reaches the switch unit output side coupler 125-1 after passing through the amplification unit coupler 113-2, the amplification unit output side port 116-2, the switch unit output side port 128, and the switch 127 in turn.

Further, the optical signal reaching the switch unit output side coupler 125-1 reaches the switch unit optical detector 126-1. In addition, the optical signal reaching the switch unit output side coupler 125-1 reaches the amplification unit filter 114-1 after passing through the switch unit input side coupler 122-1, the switch unit input side port 121-1, the amplification unit output side port 116-1, and the amplification unit coupler 113-1 in turn. A component having the first frequency band, of the optical signal reaching the amplification unit filter 114-1, reaches the amplification unit optical detector 115-1 after passing through the amplification unit filter 114-1. In the meantime, the optical signal including the amplified spontaneous emission output from the amplifier 112-2 does not reach the optical detectors 115-2 and 126-2.

Accordingly, in this case, the optical intensity detected by the optical detectors 115-1 and 126-1 is larger than the threshold and is larger than the optical intensity obtained when only the optical signal output from one of the two amplifiers 112-1 and 112-2 reaches the optical detectors 115-1 and 126-1. In this embodiment, the optical intensity detected by the optical detectors 115-1 and 126-1 is twice or more as large as the threshold.

Further, in this case, the optical intensity detected by the optical detector 115-2 is larger than the threshold. In this embodiment, the optical intensity detected by the optical detector 115-2 is larger than the threshold and is twice or less as large as the threshold. In addition, in this case, the optical intensity detected by the optical detector 126-2 is equal to or smaller than the threshold.

In this way, the optical transmission device 1-n acquires optical intensity, which is twice or more as large as the threshold, from each of the two optical detectors 115-1 and 126-1. Further, the optical transmission device 1-n acquires optical intensity, which is larger than the threshold and is twice or less as large as the threshold, from the optical detector 115-2. In addition, the optical transmission device 1-n acquires optical intensity, which is equal to or smaller than the threshold, from the optical detector 126-2.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, like before the switching, the optical signal including the amplified spontaneous emission output from the amplifier 112-1 reaches each of the optical detectors 115-1 and 126-1. In the meantime, the optical signal including the amplified spontaneous emission output from the amplifier 112-1 does not reach the optical detectors 115-2 and 126-2.

In this case, the optical signal including the amplified spontaneous emission output from the amplifier 112-2 reaches the switch unit output side coupler 125-2 after passing through the amplification unit coupler 113-2, the amplification unit output side port 116-2, the switch unit output side port 128, and the switch 127 in turn. The optical signal reaching the switch unit output side coupler 125-2 reaches the switch unit optical detector 126-2. In the meantime, the optical signal including the amplified spontaneous emission output from the amplifier 112-2 does not reach the optical detector 115-2.

Accordingly, in this case, the optical intensity detected by the optical detectors 115-1 and 126-1 is larger than the threshold. In this embodiment, the optical intensity detected by each of the optical detectors 115-1 and 126-1 is twice or less as large as the threshold.

In addition, in this case, the optical intensity detected by the optical detector 115-2 is equal to or smaller than the threshold. Further, in this case, the optical intensity detected by the optical detector 126-2 is larger than the threshold. In this embodiment, the optical intensity detected by the optical detector 126-2 is twice or less as large as the threshold.

In this way, the optical transmission device 1-n acquires optical intensity, which is larger than the threshold and is twice or less as large as the threshold, from each of the two optical detectors 115-1 and 126-1. Further, the optical transmission device 1-n acquires optical intensity, which is equal to or smaller than the threshold, from the optical detector 115-2. In addition, the optical transmission device 1-n acquires optical intensity, which is larger than the threshold and is twice or less as large as the threshold, from the optical detector 126-2.

Then, based on the optical intensity detected at the point of time before the switching and at the point of time after the switching and the intensity-connection relationship stored in the storage unit 31, the optical transmission device 1-n determines the correctness/incorrectness of connection between ports. In this case, the optical transmission device 1-n determines that connection for one port 121-1 is correct and connections for two ports 121-2 and 128 are incorrect.

### [When Connection of Each Port is Incorrect]

A case where the amplification unit output side port 116-2, the port of the transponder 40 and the amplification unit output side port 116-1 are connected to the switch unit input side port 121-1, the switch unit input side port 121-2 and the switch unit output side port 128, respectively, will be described below. In other words, a case where connections for the switch unit input side port 121-1, the switch unit input side port 121-2 and the switch unit output side port 128 are incorrect will be described.

The optical transmission device 1-n controls the switch 127 to connect the switch unit output side coupler 125-1 and the switch unit output side port 128.

In this case, an optical signal including the amplified spontaneous emission (ASE) output from the amplifier 112-1 reaches the switch unit output side coupler 125-1 after passing through the amplification unit coupler 113-1, the amplification unit output side port 116-1, the switch unit output side port 128, and the switch 127 in turn.

The optical signal reaching the switch unit output side coupler 125-1 reaches the switch unit optical detector 126-1. Further, the optical signal reaching the switch unit output side coupler 125-1 reaches the amplification unit filter 114-2 after passing through the switch unit input side coupler 122-1, the switch unit input side port 121-1, the amplification unit output side port 116-2, and the amplification unit coupler 113-2 in turn.

A component having the second frequency band, of the optical signal reaching the amplification unit filter 114-2, reaches the amplification unit optical detector 115-2 after passing through the amplification unit filter 114-2. In the meantime, the optical signal including the amplified spontaneous emission output from the amplifier 112-1 does not reach the optical detectors 115-1 and 126-2.

Further, in this case, an optical signal including the amplified spontaneous emission output from the amplifier 112-2 reaches the switch unit filter 123-1 after passing through the amplification unit coupler 113-2, the amplification unit output side port 116-2, the switch unit input side port 121-1, and the switch unit input side coupler 122-1 in turn.

A component having the first frequency band, of the optical signal reaching the switch unit filter 123-1, is reflected by the reflector 124-1 after passing through the switch unit filter 123-1. Further, the reflected optical signal reaches the amplification unit filter 114-2 after passing through the switch unit filter 123-1, the switch unit input side coupler 122-1, the switch unit input side port 121-1, the amplification unit output side port 116-2, and the amplification unit coupler 113-2 in turn.

The frequency band of the optical signal reaching the amplification unit filter 114-2 matches the first frequency and is, therefore, different from the second frequency band. Therefore, the optical signal reaching the amplification unit filter 114-2 is blocked by the amplification unit filter 114-2. Accordingly, the optical signal output from the amplifier 112-2 does not reach the amplification unit optical detector 115-2.

Further, the optical signal reaching the switch unit input side coupler 122-1 reaches the switch unit optical detector 126-1 after passing through the switch unit output side coupler 125-1. In addition, the optical signal reaching the switch unit output side coupler 125-1 reaches the amplification unit filter 114-1 after passing through the switch 127, the switch unit output side port 128, the amplification unit output side port 116-1 and the amplification unit coupler 113-1 in turn. A component having the first frequency band, of the optical signal reaching the amplification unit filter 114-1, reaches the amplification unit optical detector 115-1 after passing through the amplification unit filter 114-1. In the meantime, the optical signal output from the amplifier 112-2 does not reach the switch unit optical detector 126-2.

Accordingly, in this case, the optical intensity detected by the optical detectors 115-1 and 115-2 is larger than the threshold. In this embodiment, the optical intensity detected by the optical detectors 115-1 and 115-2 is twice or less as large as the threshold.

Further, in this case, the optical intensity detected by the optical detector 126-1 is larger than the threshold and is larger than the optical intensity obtained when only the optical signal output from one of the two amplifiers 112-1 and 112-2 reaches the optical detector 126-1. In this embodiment, the optical intensity detected by the optical detector 126-1 is twice or more as large as the threshold.

In addition, in this case, the optical intensity detected by the optical detector 126-2 is equal to or smaller than the threshold.

In this way, the optical transmission device 1-n acquires optical intensity, which is larger than the threshold and is twice or less as large as the threshold, from each of the two optical detectors 115-1 and 115-2. Further, the optical transmission device 1-n acquires optical intensity, which is twice or more as large as the threshold, from the optical detector 126-1. In addition, the optical transmission device 1-n acquires optical intensity, which is equal to or smaller than the threshold, from the optical detector 126-2.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, the optical signal including the amplified spontaneous emission output from the amplifier 112-1 reaches the switch unit output side coupler 125-2 after passing through the amplification unit coupler 113-1, the amplification unit output side port 116-1, the switch unit output side port 128, and the switch 127 in turn. The optical signal reaching the switch unit output side coupler 125-2 reaches the switch unit optical detector 126-2. In the meantime, the optical signal output from the amplifier 112-1 does not reach the optical detectors 115-1, 115-2 and 126-1.

Further, in this case, the optical signal including the amplified spontaneous emission output from the amplifier 112-2 reaches the switch unit output side coupler 125-1 after passing through the amplification unit coupler 113-2, the amplification unit output side port 116-2, the switch unit input side port 121-1, and the switch unit input side coupler 122-1 in turn. The optical signal reaching the switch unit output side coupler 125-1 reaches the switch unit optical detector 126-1. In the meantime, the optical signal output from the amplifier 112-2 does not reach the optical detectors 115-1, 115-2 and 126-2.

Accordingly, in this case, the optical intensity detected by the optical detectors 126-1 and 126-2 is larger than the threshold. In this embodiment, the optical intensity detected by each of the optical detectors 126-1 and 126-2 is twice or less as large as the threshold.

In addition, in this case, the optical intensity detected by each of the optical detectors 115-1 and 115-2 is equal to or smaller than the threshold.

In this way, the optical transmission device 1-n acquires optical intensity, which is larger than the threshold and is twice or less as large as the threshold, from each of the two optical detectors 126-1 and 126-2. Further, the optical transmission device 1-n acquires optical intensity, which is equal to or smaller than the threshold, from each of the two optical detectors 115-1 and 115-2.

Then, based on the optical intensity detected at the point of time before the switching and at the point of time after the switching and the intensity-connection relationship stored in the storage unit 31, the optical transmission device 1-n determines the correctness/incorrectness of connection between ports. In this case, the optical transmission device 1-n determines that connection for three ports 121-1, 121-2 and 128 are incorrect. In addition, the connections for the three ports 121-1, 121-2 and 128 may be described in the same manner for cases other than the above-described case.

As described above, according to the optical transmission device 1, it is possible to detect the correctness or incorrectness of connection between the switch unit input side ports 121-1 and 121-2 and the amplification unit output side ports 116-1 and 116-2 based on the optical intensity detected by the amplification unit optical detectors 115-1 and 115-2.

In addition, the optical transmission device 1 may not include the switch unit optical detectors 126-1 and 126-2. In addition, the optical transmission device 1 may not determine the correctness/incorrectness of connection for the switch unit output side port 128.

Each of the filters 114-m and 123-m may be a wavelength variable filter which is capable of changing a frequency band of transmitting optical signal. In this case, it is possible to reduce production costs of the optical transmission device 1. In addition, it is possible to change a combination of ports associated with correct connection with ease. In addition, the technique for detecting the correctness or incorrectness of connection between ports may be applied to the transmitter 20.

In addition, in the optical transmission device 1, only some of the M sets of element groups 110-1, . . . , 110-M and element groups 120-1, . . . , 120-M may have a configuration for detecting the correctness or incorrectness of connection between ports. For example, this configuration includes the amplification unit coupler 113-m, the amplification unit filter 114-m, the amplification unit optical detector 115-m, the switch unit input side coupler 122-m, the switch unit filter 123-m, the reflector 124-m, the switch unit output side coupler 125-m, and the switch unit optical detector 126-m.

### Second Embodiment

Next, an optical transmission device according to a second embodiment will be described. The optical transmission device of the second embodiment is different from the optical transmission device of the first embodiment in that the number of reflectors is one. The following description will be made with an emphasis on this difference. In the description of the second embodiment, the same or similar portions as those of the first embodiment are denoted by the same reference numerals as those used in the first embodiment.

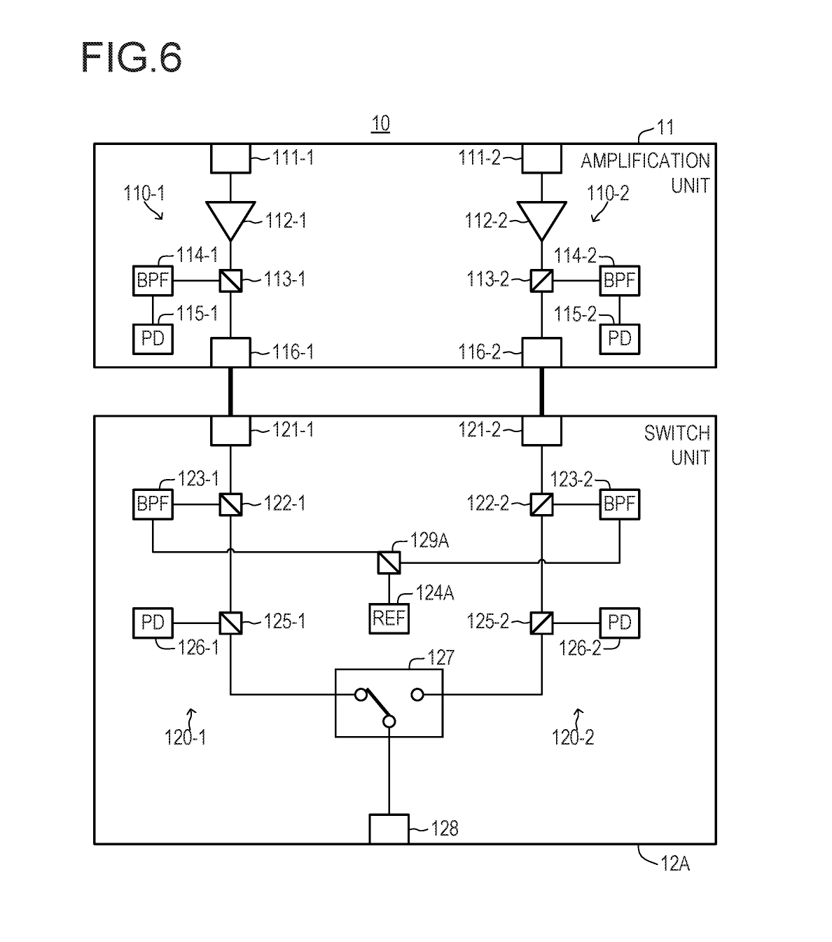

For example, as illustrated in FIG. 6, a receiver 10 of the second embodiment includes a switch unit 12A instead of the switch unit 12 included in the receiver 10 of the first embodiment. The switch unit 12A includes a reflector 124A and a reflection coupler 129A instead of the reflectors 124-1, . . . , 124-M included in the switch unit 12 of the first embodiment. The reflector 124A and the reflection coupler 129A are one example of a reflector. The reflection coupler 129A is one example of a third coupler.

The reflection coupler 129A is connected to the reflector 124A and each of the M switch unit filters 123-1, . . . , 123-M. The reflection coupler 129A combines M optical signals input from the M switch unit filters 123-1, . . . , 123-M and outputs a resultant optical signal to the reflector 124A. The reflection coupler 129A splits the resultant optical signal input from the reflector 124A into M optical signals which are then respectively output to the M switch unit filters 123-1, . . . , 123-M.

The reflector 124A reflects the optical signal input from the reflection coupler 129A and outputs the reflected optical signal to the reflection coupler 129A.

The optical transmission device 1 of the second embodiment exhibits the same operation and effects as the optical transmission device 1 of the first embodiment. Further, with the optical transmission device 1 of the second embodiment, it is possible to reduce the number of reflectors. As a result, it is possible to reduce production costs for the optical transmission device 1.

### Third Embodiment

Next, an optical transmission device according to a third embodiment will be described. The optical transmission device of the third embodiment is different from the optical transmission device of the second embodiment in that an optical detector is provided between the switch and the switch unit output side port. The following description will be made with an emphasis on this difference. In the description of the third embodiment, the same or similar portions as those of the second embodiment are denoted by the same reference numerals as those used in the second embodiment.

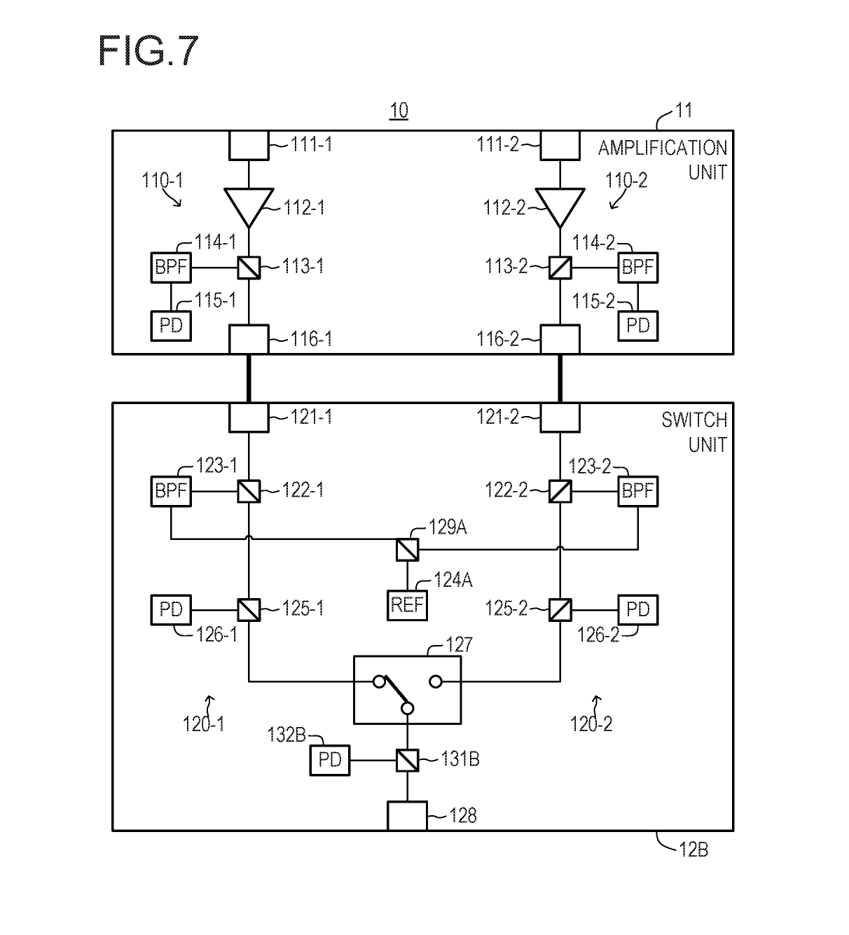

For example, as illustrated in FIG. 7, a receiver 10 of the third embodiment includes a switch unit 12B instead of the switch unit 12A included in the receiver 10 of the second embodiment. The switch unit 128 includes a switch port-to-port coupler 131B and a switch port-to-port optical detector 132B in addition to the configuration of the switch unit 12A of the second embodiment. The switch port-to-port optical detector 132B is one example of a third optical detector.

The switch port-to-port coupler 131B is connected to each of the switch 127 and the switch unit output side port 128. The switch port-to-port coupler 131B splits optical signal input from the switch 127 into two optical signals and outputs one of the two optical signals to the switch port-to-port optical detector 132B while outputting the other of the two optical signals to the switch unit output side port 128. Further, the switch port-to-port coupler 13B splits optical signal input from the switch unit output side port 128 into two optical signals and outputs one of the two optical signals to the switch port-to-port optical detector 13B while outputting the other of the two optical signals to the switch 127. In this embodiment, the switch port-to-port coupler 131B is a dual directional coupler.

The switch port-to-port optical detector 132B detects the optical intensity input from the switch port-to-port coupler 131B. In this embodiment, the switch port-to-port optical detector 132B includes a photodiode.

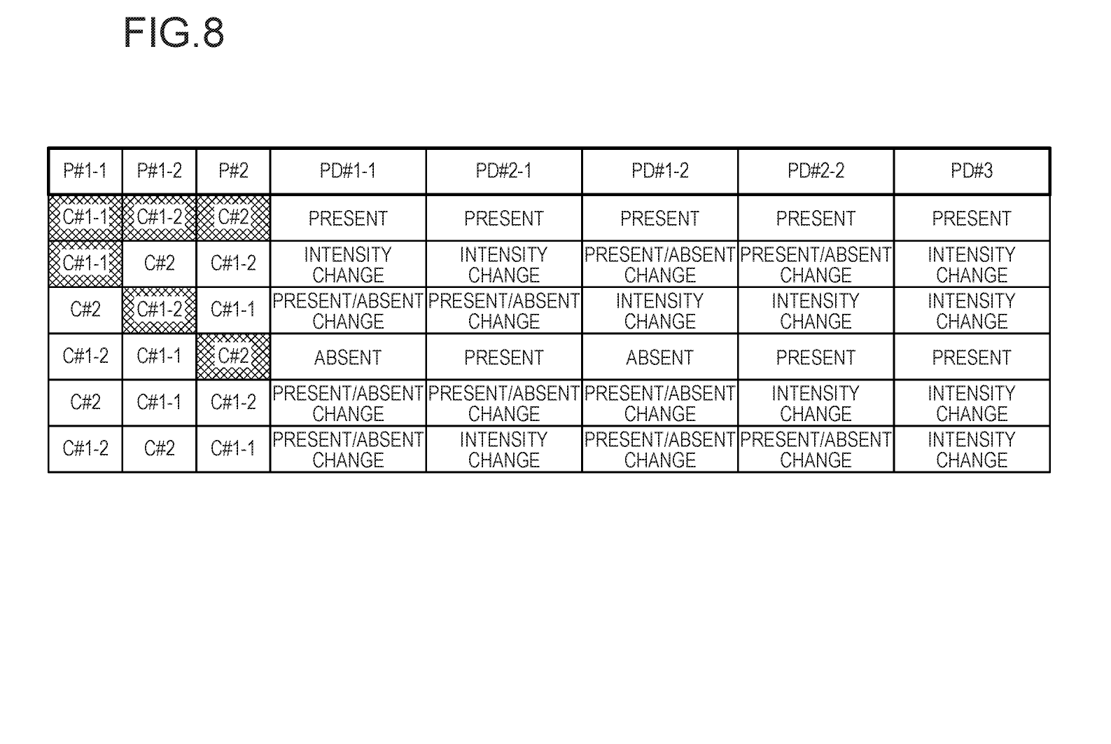

As illustrated in FIG. 8, the intensity-connection relationship stored in the storage unit 31 of the third embodiment includes a relationship between the optical intensity for each of five optical detectors 115-1, 126-1, 115-2, 126-2, and 132B and the correctness/incorrectness of connection for ports. In FIG. 8, “PD#3” denotes the switch port-to-port optical detector 132B.

In this embodiment, based on the optical intensity detected by each of the five optical detectors 115-1, 115-2, 126-1, 126-2 and 132B and the intensity-connection relationship, the processing unit 32 determines the correctness/incorrectness of connection for each of three ports 121-1, 121-2 and 128.

The detection of optical intensity by the switch port-to-port optical detector 132B in the operation of the optical transmission device 1 of the third embodiment will be described.

### [When Connection of Each Port is Correct]

A case where the amplification unit output side port 116-1, the amplification unit output side port 116-2, and the port of the transponder 40 are connected to the switch unit input side port 121-1, the switch unit input side port 121-2, and the switch unit output side port 128, respectively, will be described below.

The optical transmission device 1-n controls the switch 127 to connect the switch unit output side coupler 125-1 and the switch unit output side port 128.

In this case, an optical signal including amplified spontaneous emission (ASE) output from the amplifier 112-1 reaches the switch unit output side coupler 125-1 after passing through the amplification unit coupler 113-1, the amplification unit output side port 116-1, the switch unit input side port 121-1, and the switch unit input side coupler 122-1 in turn. The optical signal reaching the switch unit output side coupler 125-1 reaches the switch port-to-port optical detector 132B after passing through the switch 127 and the switch port-to-port coupler 131B in turn.

In the meantime, an optical signal including the amplified spontaneous emission output from the amplifier 112-2 does not reach the switch port-to-port optical detector 132B. Accordingly, in this case, the optical intensity detected by the switch port-to-port optical detector 132B is larger than the threshold. In this embodiment, the optical intensity detected by the switch port-to-port optical detector 132B is larger than the threshold and is twice or less as large as the threshold.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, the optical signal including the amplified spontaneous emission output from the amplifier 112-1 does not reach the switch port-to-port optical detector 132B. In the meantime, the optical signal including the amplified spontaneous emission output from the amplifier 112-2 reaches the switch unit output side coupler 125-2 after passing through the amplification unit coupler 113-2, the amplification unit output side port 116-2, the switch unit input side port 121-2, and the switch unit input side coupler 122-2 in turn. The optical signal reaching the switch unit output side coupler 125-2 reaches the switch port-to-port optical detector 132B after passing through the switch 127 and the switch port-to-port coupler 131B in turn. Accordingly, in this case, the optical intensity detected by the switch port-to-port optical detector 132B is larger than the threshold. In this embodiment, the optical intensity detected by the switch port-to-port optical detector 132B is larger than the threshold and is twice or less as large as the threshold.

In this way, the optical intensity detected by the switch port-to-port optical detector 132B is larger than the threshold and is not changed before and after the switching.

### [When Only Connection of One Port is Correct]

A case where the amplification unit output side port 116-1, the port of the transponder 40, and the amplification unit output side port 116-2 are connected to the switch unit input side port 121-1, the switch unit input side port 121-2, and the switch unit output side port 128, respectively, will be described below.

The optical transmission device 1-n controls the switch 127 to connect the switch unit output side coupler 125-1 and the switch unit output side port 128.

In this case, the optical signal including the amplified spontaneous emission output from the amplifier 112-1 reaches the switch port-to-port optical detector 132B since this optical signal is guided in the same manner as the above-described case. In the meantime, the optical signal including the amplified spontaneous emission output from the amplifier 112-2 reaches the switch port-to-port optical detector 132B after passing through the amplification unit coupler 113-2, the amplification unit output side port 116-2, the switch unit output side port 128, and the switch port-to-port coupler 131B in turn.

Accordingly, in this case, the optical intensity detected by the switch port-to-port optical detector 132B is larger than the optical intensity obtained when only the optical signal output from one of the two amplifiers 112-1 and 112-2 reaches the switch port-to-port optical detector 132B. In this embodiment, the optical intensity detected by the switch port-to-port optical detector 132B is twice or more as large as the threshold.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, the optical signal including the amplified spontaneous emission output from the amplifier 112-1 does not reach the switch port-to-port optical detector 132B. In the meantime, the optical signal including the amplified spontaneous emission output from the amplifier 112-2 reaches the switch port-to-port optical detector 132B since this optical signal is guided in the same manner as before the switching.

Accordingly, in this case, the optical intensity detected by the switch port-to-port optical detector 132B is larger than the threshold and is smaller than the optical intensity detected by the switch port-to-port optical detector 132B before the switching. In this embodiment, the optical intensity detected by the switch port-to-port optical detector 132B is larger than the threshold and is twice or less as large as the threshold.

### [When Connection of Each Port is Incorrect]

A case where the amplification unit output side port 116-2, the port of the transponder 40, and the amplification unit output side port 116-1 are connected to the switch unit input side port 121-1, the switch unit input side port 121-2, and the switch unit output side port 128, respectively, will be described below.

The optical transmission device 1-n controls the switch 127 to connect the switch unit output side coupler 125-1 and the switch unit output side port 128.

In this case, an optical signal including amplified spontaneous emission (ASE) output from the amplifier 112-1 reaches the switch port-to-port optical detector 132B after passing through the amplification unit coupler 113-1, the amplification unit output side port 116-1, the switch unit output side port 128, and the switch port-to-port coupler 131B in turn.

In the meantime, an optical signal including the amplified spontaneous emission output from the amplifier 112-2 reaches the switch unit output side coupler 125-1 after passing through the amplification unit coupler 113-2, the amplification unit output side port 116-2, the switch unit input side port 121-1, and the switch unit input side coupler 122-1 in turn. The optical signal reaching the switch unit output side coupler 125-1 reaches the switch port-to-port optical detector 132B after passing through the switch 127 and the switch port-to-port coupler 1318 in turn.

Accordingly, in this case, the optical intensity detected by the switch port-to-port optical detector 132B is larger than the optical intensity obtained when only the optical signal output from one of the two amplifiers 112-1 and 112-2 reaches the switch port-to-port optical detector 132B. In this embodiment, the optical intensity detected by the switch port-to-port optical detector 132B is twice or more as large as the threshold.

Next, the optical transmission device 1-n controls the switch 127 to connect the switch unit output side coupler 125-2 and the switch unit output side port 128. In other words, the optical transmission device 1-n controls the switch 127 to switch the switch unit output side coupler 125-m connected to the switch unit output side port 128 from the switch unit output side coupler 125-1 to the switch unit output side coupler 125-2.

In this case, the optical signal including the amplified spontaneous emission output from the amplifier 112-1 reaches the switch port-to-port optical detector 132B since this optical signal is guided in the same manner as before the switching. In the meantime, the optical signal including the amplified spontaneous emission output from the amplifier 112-2 does not reach the switch port-to-port optical detector 132B.

Accordingly, in this case, the optical intensity detected by the switch port-to-port optical detector 132B is larger than the threshold and is smaller than the optical intensity detected by the switch port-to-port optical detector 132B before the switching. In this embodiment, the optical intensity detected by the switch port-to-port optical detector 132B is larger than the threshold and is twice or less as large as the threshold.

In this way, based on the optical intensity detected by each of the optical detectors 115-1, 115-2, 126-1, 126-2 and 132B and the intensity-connection relationship, the optical transmission device 1 of the third embodiment determines the correctness/incorrectness of connection for each of the ports 121-1, 121-2, and 128.

The optical transmission device 1 of the third embodiment also exhibits the same operation and effects as the optical transmission device 1 of the first embodiment. Further, with the optical transmission device 1 of the third embodiment, it is possible to determine the correctness/incorrectness of connection between ports with high precision.

### Fourth Embodiment

Next, an optical transmission device according to a fourth embodiment will be described. The optical transmission device of the fourth embodiment is different from the optical transmission device of the first embodiment in that a plurality of switch unit output side ports is provided. The following description will be made with an emphasis on this difference. In the description of the fourth embodiment, the same or similar portions as those of the first embodiment are denoted by the same reference numerals as those used in the first embodiment.

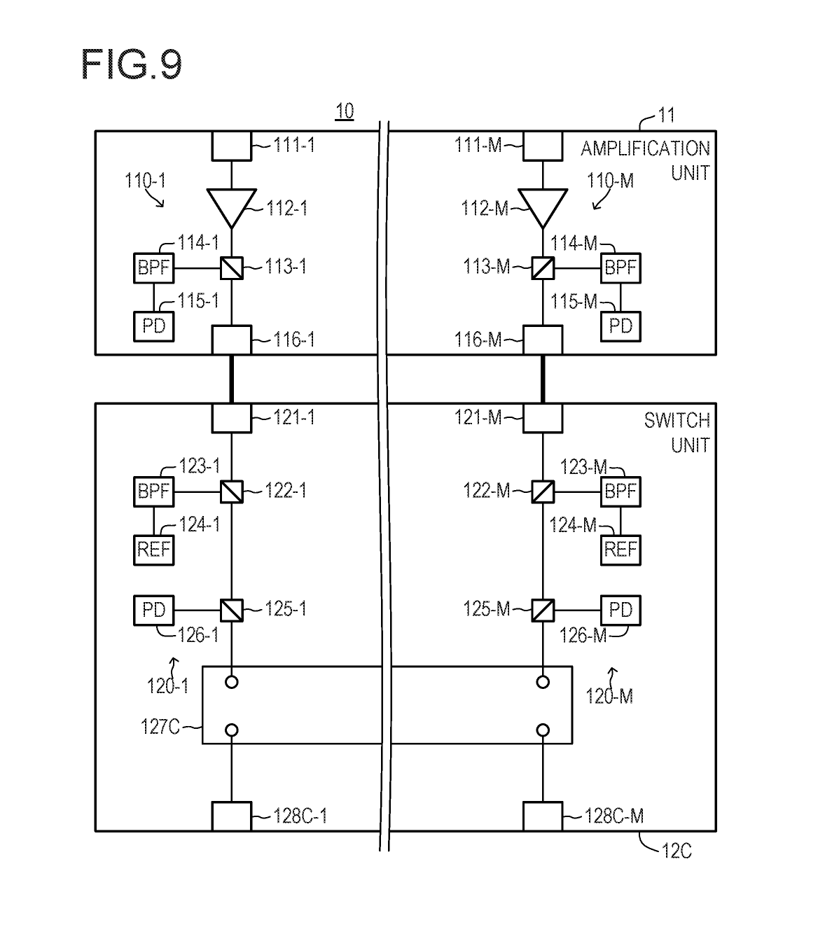

For example, as illustrated in FIG. 9, a receiver 10 of the fourth embodiment includes a switch unit 12C instead of the switch unit 12 included in the receiver 10 of the first embodiment. The switch unit 12C includes a switch 127C and M switch unit output side ports 128C-1, . . . , 128C-M instead of the switch 127 and the switch unit output side port 128 included in the switch unit 12 of the first embodiment.

The switch 127C is connected to each of the M switch unit output side ports 128C-1, . . . , 128C-M and each of the M switch unit output side couplers 125-1, . . . , 125-M. The switch 127C connects each of the M switch unit output side ports 128C-1, . . . , 128C-M and one of the M switch unit output side couplers 125-1, . . . , 125-M. Further, the switch 127C switches a switch unit output side coupler 125-m connected to each of the M switch unit output side ports 128C-1, . . . , 128C-M, among the M switch unit output side couplers 125-1, . . . , 125-M. The switch 127C may represent a cross-connect switch.

When the switch 127C connects a switch unit output side port 128-p and a switch unit output side coupler 125-m, the switch 127C outputs optical signal input from the switch unit output side port 128-p to a switch unit output side coupler 125-m. Further, in this case, the switch 127C outputs optical signal input from the switch unit output side coupler 125-m to the switch unit output side port 128-p. Here, p represents an integer from 1 to M.

Each of the M switch unit output side ports 128C-1, . . . , 128C-M is connected to the switch 127C. Further, each of the M switch unit output side ports 128C-1, . . . , 128C-M is, for example, configured to allow its one end to be connected to the other end of a communication cable connected to the transponder 40. Each of the M switch unit output side ports 128C-1, . . . , 128C-M outputs optical signal input from the communication cable to the switch 127C while outputting optical signal input from the switch 127C to the communication cable.

The optical transmission device 1 of the fourth embodiment also exhibits the same operation and effects as the optical transmission device 1 of the first embodiment.

### Fifth Embodiment

Next, an optical transmission device according to a fifth embodiment will be described. The optical transmission device of the fifth embodiment is different from the optical transmission device of the first embodiment in that a transmitter detects the correctness or incorrectness of connection between ports. The following description will be made with an emphasis on this difference. In the description of the fifth embodiment, the same or similar portions as those of the first embodiment are denoted by the same reference numerals as those used in the first embodiment.

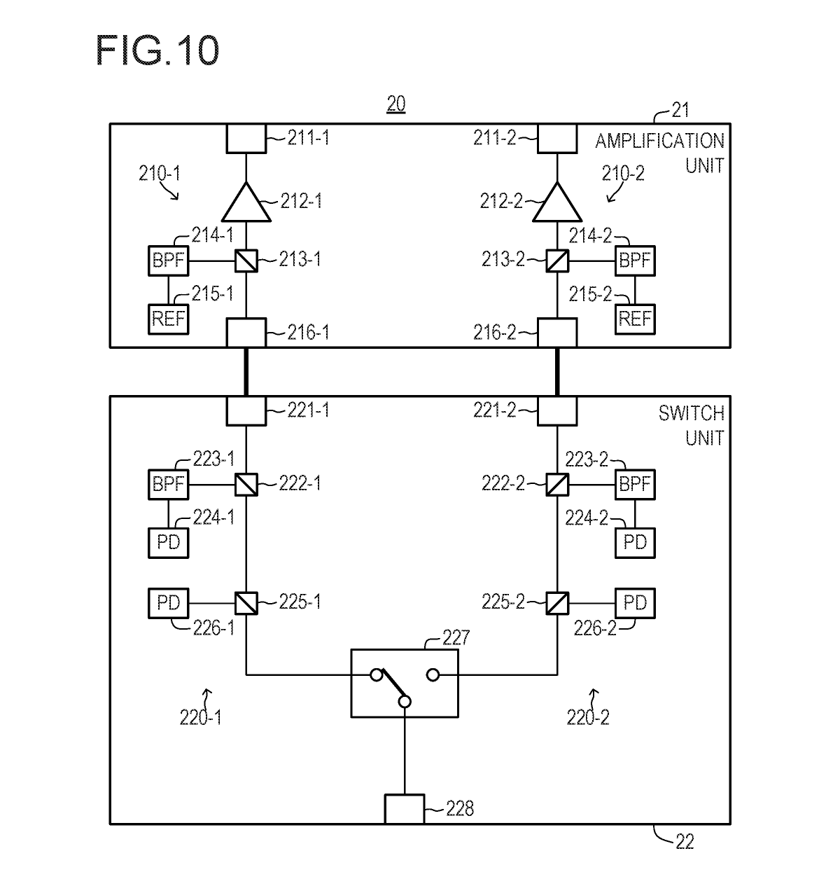

For example, as illustrated in FIG. 10, a transmitter 20 of the fifth embodiment includes an amplification unit 21 and a switch unit 22. The amplification unit 21 and the switch unit 22 may be separately configured with two different devices.

The amplification unit 21 includes M sets of element groups 210-1, . . . , 210-M. In the following description, an element group 210-m is also referred to as an element group 210 as long as it is not necessary to distinguish one from another. The M sets of element groups 210-1, . . . , 210-M may be separately configured with M different devices.

The element group 210-m includes an amplification unit output side port 211-m, an amplifier 212-m, an amplification unit coupler 213-m, an amplification unit filter 214-m, a reflector 215-m and an amplification unit input side port 216-m.

The amplification unit coupler 213-m is one example of a second coupler. The amplification unit filter 214-m is one example of a second filter. M reflectors 215-1, . . . , 215-M are one example of a reflector. The amplification unit input side port 216-m is one example of a second port.

The amplification unit output side port 211-m is, for example, configured to allow its one end to be connected to the other end of a communication cable connected to the other optical transmission device 1-i or 1-j. In addition, the amplification unit output side port 211-m is connected to an output terminal of the amplifier 212-m, as will be described later.

The amplifier 212-m has an input terminal which receives optical signal and is connected to the amplification unit coupler 213-m. The amplifier 212-m amplifies the optical signal input from the input terminal. In this embodiment, the amplifier 212-m is an erbium doped fiber amplifier (EDFA). The amplifier 212-m has the output terminal which outputs the amplified optical signal and is connected to the amplification unit output side port 211-m .

The amplification unit coupler 213-m is connected to each of the input terminal of the amplifier 212-m, the amplification unit filter 214-m and the amplification unit input side port 216-m. The amplification unit coupler 213-m splits the optical signal input from the amplification unit input side port 216-m into two optical signals and outputs one of the two optical signals to the amplification unit filter 214-m while outputting the other of the two optical signals to the input terminal of the amplifier 212-m. Further, the amplification unit coupler 213-m outputs the optical signal, which is input from the amplification unit filter 214-m, to the amplification unit input side port 216-m. In this embodiment, the amplification unit coupler 213-m is a single directional coupler.

The amplification unit filter 214-m is connected to each of the amplification unit coupler 213-m and the reflector 215-m. The amplification unit filter 214-m transmits a component of the input optical signal which has an M^{th} frequency band. In this embodiment, the amplification unit filter 214-m outputs the component haying the M^{th} frequency band, of the optical signal input from the amplification unit coupler 213-m, to the reflector 215-m while blocking components haying frequencies different from the M^{th} frequency band, of the input optical signal. Further, in this embodiment, the amplification unit filter 214-m outputs the component haying the M^{th} frequency band, of the optical signal input from the reflector 215-m, to the amplification unit coupler 213-m while blocking components haying frequencies different from the M^{th} frequency band, of the input optical signal.

The reflector 215-m is connected to the amplification unit filter 214-m. The reflector 215-m reflects optical signal input from the amplification unit filter 214-m and outputs the reflected optical signal to the amplification unit filter 214-m.

The amplification unit input side port 216-m is connected to the amplification unit coupler 213-m. Further, the amplification unit input side port 216-m is, for example, configured to allow its one end to be connected to the other end of a communication cable connected to a switch unit output side port 221-m described later. The amplification unit input side port 216-m outputs optical signal, which is input from the communication cable, to the amplification unit coupler 213-m while outputting optical signal, which is input from the amplification unit coupler 213-m, to the communication cable.

The switch unit 22 includes M sets of element groups 220-1, . . . , 220-M, a switch 227, and a switch unit input side port 228. In the following description, an element group 220-m is also referred to as an element group 220 as long as it is not necessary to distinguish one from another.

The element group 220-m includes a switch unit output side port 221-m, a switch unit output side coupler 222-m, a switch unit filter 223-m, a switch unit output side optical detector 224-m, a switch unit input side coupler 225-m, and a switch unit input side optical detector 226-m.

The switch unit output side port 221-m is one example of a first port. The switch unit output side coupler 222-m is one example of a first coupler. The switch unit filter 223-m is one example of a first filter. The switch unit output side optical detector 224-m is one example of a first optical detector. The switch unit input side optical detector 226-m is one example of a second optical detector.

The switch unit output side port 221-m is, for example, configured to allow its one end to be connected to the other end of a communication cable connected to the amplification unit input side port 216-m. In addition, the switch unit output side port 221-m is connected to the switch unit output side coupler 222-m. The switch unit output side port 221-m outputs optical signal, which is input from the communication cable, to the switch unit output side coupler 222-m and outputs optical signal, which is input from the switch unit output side coupler 222-m, to the communication cable.

The switch unit output side coupler 222-m is connected to each of the switch unit output side port 221-m, the switch unit filter 223-m, and the switch unit input side coupler 225-m. The switch unit output side coupler 222-m splits the optical signal input from the switch unit output side port 221-m into two optical signals and outputs one of the two optical signals to the switch unit filter 223-m while outputting the other of the two optical signals to the switch unit input side coupler 225-m.

Further, the switch unit output side coupler 222-m outputs optical signal, which is input from the switch unit input side coupler 225-m, to the switch unit output side port 221-m. In addition, the switch unit output side coupler 222-m outputs optical signal, which is input from the switch unit filter 223-m, to the switch unit output side port 221-m. In this embodiment, the switch unit output side coupler 222-m is a single directional coupler.

The switch unit filter 223-m is connected to each of the switch unit output side coupler 222-m and the switch unit output side optical detector 224-m. The switch unit filter 223-m transmits a component having an M^{th} frequency band, of the input optical signal.

In this embodiment, the switch unit filter 223-m outputs a component having an M^{th} frequency band, of the optical signal input from the switch unit output side coupler 222-m, to the switch unit output side optical detector 224-m while blocking components having frequencies different from the M^{th} frequency band, of the input optical signal.

In this way, a frequency band of the optical signal transmitting through the switch unit filter 223-m (in other words, the M^{th} frequency band) matches a frequency band of the optical signal transmitting through the amplification unit filter 214-m corresponding to the switch unit filter 223-m (in other words, the M^{th} frequency band).

The switch unit output side optical detector 224-m is connected to the switch unit filter 223-m. The switch unit output side optical detector 224-m detects the optical intensity input from the switch unit filter 223-m (in other words, optical signal transmitted through the switch unit filter 223-m). In this embodiment, the switch unit output side optical detector 224-m includes a photodiode.

The switch unit input side coupler 225-m is connected to each of the switch unit output side coupler 222-m, the switch unit input side optical detector 226-m and the switch 227. The switch unit input side coupler 225-m splits the optical signal input from the switch unit output side coupler 222-m into two optical signals and outputs one of the two optical signals to the switch unit input side optical detector 226-m while outputting the other of the two optical signals to the switch 227. In addition, the switch unit input side coupler 225-m splits the optical signal input from the switch 227 into two optical signals and outputs one of the two optical signals to the switch unit input side optical detector 226-m while outputting the other of the two optical signals to the switch unit output side coupler 222-m. In this embodiment, the switch unit input side coupler 225-m is a dual directional coupler.

The switch unit input side optical detector 226-m is connected to the switch unit input side coupler 225-m. The switch unit input side optical detector 226-m detects the optical intensity input from the switch unit input side coupler 225-m. In this embodiment, the switch unit input side coupler 225-m includes a photodiode.

The switch 227 is connected to the switch unit input side port 228 and each of M switch unit input side couplers 225-1, . . . , 225-M. The switch 227 connects the switch unit input side port 228 and one of the M switch unit input side couplers 225-1, . . . , 225-M. Further, the switch 227 switches the switch unit input side coupler 225-m connected to the switch unit input side port 228, among the M switch unit input side couplers 225-1, . . . , 225-M.

When connecting the switch unit input side port 228 and the switch unit input side coupler 225-m, the switch 227 outputs optical signal, which is input from the switch unit input side port 228, to the switch unit input side coupler 225-m. Further, in this case, the switch 227 outputs optical signal, which is input from the switch unit input side coupler 225-m, to the switch unit input side port 228.

The switch unit input side port 228 is connected to the switch 227. Further, the switch unit input side port 228 is, for example, configured to allow its one end to be connected to the other end of a communication cable connected to the transponder 40. The switch unit input side port 228 outputs optical signal, which is input from the communication cable, to the switch 227 while outputting optical signal, which is input from the switch 227, to the communication cable.

In this embodiment, the switch unit output side port 128 is connected to the switch unit input side port 228. Accordingly, in the receiver 10, the amplified spontaneous emission output by the amplifier 112-1 or the amplifier 112-2 is input to the switch unit input side port 228.

The processing unit 32 determines the correctness/incorrectness of connection for each of the three ports 221-1, 221-2 and 228 based on the optical intensity detected by each of the four optical detectors 224-1, 224-2, 226-1, and 226-2 and the intensity-connection relationship stored in the storage unit 31.

In this embodiment, the processing unit 32 controls the switch 227 to switch the switch unit input side coupler 225-m connected to the switch unit input side port 228. The processing unit 32 acquires the optical intensity detected by each of the four optical detectors 224-1, 224-2, 226-1, and 226-2 at the point of time before the switching and at the point of time after the switching.

The processing unit 32 determines whether or not the acquired optical intensity is larger than the threshold. Further, based on a result of the determination and the intensity-connection relationship stored in the storage unit 31, the processing unit 32 determines the correctness/incorrectness of connection for each of the three ports 221-1, 221-2 and 228.

The optical transmission device 1 of the fifth embodiment exhibits the same operation and effects as the optical transmission device 1 of the first embodiment. Further, with the optical transmission device 1 of the fifth embodiment, it is possible to detect the correctness or incorrectness of connection between the switch unit output side ports 221-1 and 221-2 and the amplification unit input side ports 216-1 and 216-2 based on the optical intensity detected by the switch unit output side optical detectors 224-1 and 224-2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission device comprising:
a first coupler to which an optical signal including an amplified spontaneous emission is input;
a first filter configured to transmit the optical signal having a first frequency band from the first coupler;
a first optical detector configured to detect an optical intensity of the optical signal transmitted through the first filter;
a first port coupled to the first coupler;
a second port configured to be coupled to the first port;
a second coupler coupled to the second port;
a second filter configured to transmit the optical signal having a second frequency band matching the first frequency band from the second coupler; and
a reflector configured to reflect the optical signal from the second filter.

2. The optical transmission device according to claim 1, further comprising
a plurality of groups into which a group is formed, the group including the first coupler, the first filter, the first optical detector, the first port, the second port, the second coupler, the second filter, and the reflector,
wherein a plurality of first frequency bands of a plurality of first filters included in the plurality of groups are different from each other, and
wherein the second frequency band matches the first frequency band in the group.

3. The optical transmission device according to claim 2, further comprising:
a third port; and
a switch configured to couple to the third port and a plurality of second couplers, and connect the third port and one of the plurality of second couplers.

4. The optical transmission device according to claim 3, further comprising:
a plurality of second optical detectors each configured to detect an optical intensity of the optical signal transmitted through between the switch and one of the plurality of second couplers.

5. The optical transmission device according to claim 3, further comprising:
a third optical detector configured to detect the optical intensity of the optical signal transmitted through between the switch and the third port.

6. The optical transmission device according to claim 2,
wherein the reflector is configured to include:
a third coupler coupled to each of the plurality of second filters; and
a reflector configured to reflect an optical signal from the third coupler.

7. The optical transmission device according to claim 2, further comprising:
a memory configured to store data for indicating a relationship between an optical intensity and a correctness and incorrectness of connection between a plurality of first ports and a plurality of second ports included in the plurality of groups; and
a hardware processor configured to determine a correctness or incorrectness of connection between the plurality of first ports and the plurality of second ports, based on the optical intensity detected by a plurality of first optical detectors included in the plurality of groups and the relationship stored at the memory.

8. A method for determining connection comprising:
transmitting an optical signal including an amplified spontaneous emission to a first port;
transmitting the optical signal from the first port to a second port coupled to the first port
transmitting the optical signal from the second port to a second filter to transmit the optical signal having a second frequency band;
reflecting the optical signal transmitted through the second filter;
transmitting the reflected optical signal to the second port;
transmitting the optical signal from the second port to the first port;
transmitting the optical signal transmitted in turn from the second port and the first port to a first filter to transmit the optical signal having a first frequency band matching the second frequency band;
detecting an optical intensity of the optical signal transmitted through the first filter; and
determining a correctness or incorrectness of connection between the first port and the second port based on the detected optical intensity.

9. A method for determining connection comprising:
transmitting an optical signal including an amplified spontaneous emission to a plurality of first ports;
transmitting the optical signals from the plurality of first ports to a plurality of second ports coupled to the plurality of first ports, respectively;
transmitting the optical signals from the plurality of second ports to a plurality of second filters to transmit the optical signals, respectively, the plurality of second filters having a plurality of second frequency bands different from each other;
reflecting the optical signals transmitted through the plurality of second filters, respectively;
transmitting the reflected optical signals to the plurality of second ports, respectively;
transmitting the optical signals from the plurality of second ports to the plurality of first ports, respectively;
transmitting the optical signals transmitted in turn from the plurality of second ports and the plurality of first ports, respectively, to a plurality of first filters to transmit the optical signals, respectively, the plurality of first optical filters having a plurality of first frequency bands matching the plurality of second frequency bands, respectively;
detecting optical intensities of the optical signals transmitted through the plurality of first filters, respectively; and
determining correctness or incorrectness of connection between the plurality of first ports and the plurality of second ports based on the detected optical intensities, respectively.

10. The method according to claim 9, further comprising:
transmitting a first optical signal transmitted from one second port of the plurality of second ports to a third port through a switch;
detecting a first optical intensity of the first optical signal;
transmitting a second optical signal transmitted from another second port of the plurality of second ports to the third port through the switch;
detecting a second optical intensity of the second optical signal; and
determining the correctness or incorrectness of connection between the plurality of second ports coupled to the third port based on the first and second optical intensities,
wherein the switch is coupled to the plurality of second ports and the third port so that any one of the plurality of second ports is coupled to the third port by the switch.

11. The method according to claim 9, further comprising:
combining the optical signals transmitted through the plurality of second filters; and
reflecting the optical signals combined.

12. The method according to claim 9, further comprising:
determining the correctness or incorrectness of connection between the plurality of first ports and the plurality of second ports, based on the optical intensities detected and a relationship between an optical intensity and a correctness and incorrectness of connection between the plurality of first ports and the plurality of second ports.
